(19) United States
(12) Patent Application Publication
(10) Pub. No.: US 2024/0424654 A1
(43) Pub. Date: Dec. 26, 2024

(54) HAND-HELD PULLING AND COMPRESSION DEVICE AND MECHANICAL FORCE AMPLIFIER

(71) Applicant: TKR Spezialwerkzeuge GmbH, Gevelsberg (DE)

(72) Inventor: Torsten KREISCHER, Wetter (DE)

(21) Appl. No.: 18/752,705

(22) Filed: Jun. 24, 2024

(30) Foreign Application Priority Data
Jun. 26, 2023 (DE) 10 2023 116 741.3

(51) Int. Cl. B25F 3/00; B21J 15/10; B21J 15/26

(52) U.S. Cl. CPC B25F 3/00; B21J 15/105; B21J 15/26

(57) ABSTRACT

The invention relates to a hand-held pulling and compression device and a mechanical force amplifier for a hand-held pulling and compression device for driving pulling and pressing tools. The hand-held pulling and compression device for driving interchangeable tools has a drive unit comprising a battery-operated electric motor, a first screw drive with a first threaded spindle mounted rotatably on a housing body and a threaded nut mounted rotatably on the first threaded spindle and non-rotatably on the housing body via a bearing unit, and a coupling unit connectable to a tool holder for transmitting tensile and compressive forces resulting from the direction of rotation of the first threaded spindle from the first threaded nut to the tool holder. In order to provide a mechanical force amplifier for a hand-held pulling and compression device and a hand-held pulling and compression device which can be easily and flexibly adapted to different work operations, it is provided that the mechanical force amplifier has a connecting section for detachably fixing the mechanical force amplifier to a connection section of the housing body of the hand-held pulling and compression device and a tool connection for pulling and compression tools.

The invention relates to a hand-held pulling and compression device and a mechanical force amplifier for a hand-held pulling and compression device for driving pulling and pressing tools.

Hand-held pulling and compression devices, i.e. devices that can be used by a person on a mobile basis, such as hand-held, electric riveting and pressing devices for setting blind rivet elements, such as blind rivets and blind rivet nuts, or for carrying out punching processes and for setting punch rivets, which have a drive unit with an electric motor-driven threaded spindle of a screw drive, are known from the prior art in a wide variety of embodiments. The screw drive converts a rotational movement of the electric motor into a linear movement of the pulling and pressing tool in a known manner. In the case of the setting operation of a blind rivet element, for example, a mandrel of the blind rivet element is moved axially.

The hand-held pulling and compression devices described above are used, for example, in vehicle workshops when carrying out repair work on the bodywork of vehicles and for maintenance work on tube or cable connections. Depending on the work to be carried out, it is necessary to use the pulling and compression devices to drive a large number of different interchangeable tools, for example with different levels of forces.

Known hand-held devices that enable the operation of both pulling and pressing tools have the disadvantage that their application possibilities are limited by the design of the device, in particular the screw drive and/or the drive unit.

Based on this, the invention is based on the object of providing a mechanical force amplifier for a hand-held pulling and compression device and a hand-held pulling and compression device which can be easily and flexibly adapted to different work operations.

The invention solves the object by a mechanical force amplifier with the features of claim 1 and by a hand-held pulling and compression device with the features of claim 7. Advantageous further embodiments of the mechanical force amplifier are given in claims 2 to 6. Further advantageous embodiments of the hand-held pulling and compression device are given in claims 8 to 9.

The hand-held pulling and compression device is connected via a coupling unit to a tool holder, which is designed to interchangeably hold different pulling and pressing tools required for the respective application. For example, when used as a compression device, the tool holder can be designed to hold a riveter, which is used in conjunction with a rivet clamp arranged on the compression device for setting rivets. When used as a pulling device, the tool holder can, for example, be provided with suitable clamping devices for a shank of the blind rivet or have other means for transmitting tensile forces. Alternatively or additionally, the tool holder can also be designed to hold corresponding pulling tools, whereby the pulling tools have, for example, clamping means by means of which the tensile forces can then be transmitted.

The coupling unit is connected to the first threaded nut in such a way that both tensile and compressive forces, which result from the direction of movement of the first threaded spindle and the resulting linear adjustment of the first threaded nut, are reliably transmitted to the coupling unit.

According to the invention, the pulling and compression device is detachably connected to a mechanical force amplifier according to the invention or further developed as described below.

Preferably, the pulling and compression device has a switching unit which can be adjusted between a coupling state connecting the first threaded spindle to the drive unit and a decoupling state separating the first threaded spindle from the drive unit. The switching unit is understood to be a unit which is intended to connect the first screw drive decoupled from the drive unit to the latter or to separate the first screw drive connected to the drive unit from the latter. The switching unit is preferably designed in such a way that the first screw drive can be decoupled from the drive unit manually or, particularly preferably, automatically. The switching unit enables the first threaded drive to be decoupled from the drive unit, as a result of which the rotational movement of the electric motor is not transmitted to the first threaded spindle and thus the linear adjustment of the first threaded nut and/or the coupling unit and/or the tool holder is blocked. Furthermore, by decoupling the first screw drive from the drive unit, the switching unit enables the torque of the electric motor to be tapped independently of the first screw drive, for example by arranging a rotating shaft.

Characteristic of the mechanical force amplifier according to the invention (hereinafter referred to as force amplifier) are a connecting section for detachably fixing the mechanical force amplifier to a connection section of the housing body of the hand-held pulling and compression device and a tool connection for pulling and compression tools. A mechanical force amplifier is understood to be a unit which is designed to increase the tensile and compressive forces generated by the hand-held pulling and compression device by mechanical means and to transmit them to a pulling or compression tool. Preferably, the force amplifier is designed in such a way that the torque generated by the drive unit of the pulling and compression device is converted by means of the force amplifier into higher tensile and compressive forces compared to the tensile and compressive forces generated by the first screw drive. Particularly preferably, the force amplifier is connected to the drive unit of the pulling and compression device in such a way that the torque of the drive unit is transmitted to the force amplifier and converted by it into tensile and compressive forces.

The mechanical force amplifier makes it possible to easy retrofit a pulling and compression device that is limited by its original design so that it can be used with an increased pressing force for different work operations. The force amplifier can be connected to a tensile and compressive tool via the tool connection so that the increased tensile and compressive forces are transferred to the tensile and compressive tool. Switching between the use of tensile and compressive forces generated by the pulling and compression device and the tensile and compressive forces increased by the force amplifier can be done easily by disassembling and assembling the force amplifier.

According to an advantageous further development of the invention, it is provided that the force amplifier has a coupling section for detachable connection to the first threaded spindle and/or the drive unit of the pulling and compression device.

Preferably, the force amplifier is connected via the coupling section of a rotating shaft which is connected to the drive unit of the pulling and compression device. Particularly preferably, the first threaded spindle of the pulling and compression device is designed as a hollow spindle for receiving the rotating shaft. The force amplifier is reliably connected to the first threaded spindle or preferably to the drive unit of the pulling and compression device via its coupling section.

To increase the force transmitted to the tension and compression tool, the force amplifier can in principle be of any design. According to an advantageous further development of the invention, however, it is provided that the force amplifier has a second screw drive with a second threaded spindle mounted rotatably on a base body and having the coupling section, and a second threaded nut mounted rotatably on the second threaded spindle and non-rotatably on the base body via a supporting unit. The second threaded spindle of the force amplifier is preferably rigidly connectable to the first threaded spindle or the rotating shaft of the pulling and compression device via the coupling section.

The design of the second screw drive for converting the rotational movement of the drive unit of the hand-held pulling and compression device, in particular the rotating shaft, into a linear movement of the second threaded nut and thus of the pulling or pressing tool in operative connection with the second threaded nut is basically freely selectable. The second screw drive is preferably designed in such a way that a tensile and compressive force of 2-10 tons, preferably 4-8 tons, acts on the tool holder.

It is particularly preferred that the second screw drive is designed as a ball screw drive or planetary screw drive. The use of such screw drives with balls or rollers as rolling elements is characterized by the fact that, in contrast to trapezoidal screw drives, in which surfaces rub against each other, they have a particularly high degree of efficiency, which makes it possible to reduce the dimensions of the electric motor in order to achieve the desired tensile forces or compression pressures, so that the hand-held pulling and compression device can be designed to be particularly compact. Typical thread pitches of ball screw drives or planetary screw drives are 5 to 10 mm. Preferably, the second threaded spindle has a pitch of 2-8 mm, more preferably 3-7 mm, most preferably 4-6 mm. Particularly preferably, the second threaded spindle has a smaller pitch than the first threaded spindle of the hand-held pulling and compression device.

According to an advantageous further development of the invention, it is provided that the force amplifier has a coupling element that can be connected to the tool holder for transmitting tensile and compressive forces resulting from the direction of rotation of the second threaded spindle from the second threaded nut to the tool holder. Preferably, the tool holder is operatively connected to the second threaded nut in such a way that tensile and compressive forces resulting from the direction of rotation of the second threaded spindle are transmitted to the tool holder. The design of the coupling element with the threaded nut required for this is basically freely selectable. Preferably, the coupling element is designed like the coupling unit of the hand-held pulling and compression device in order to enable a cost-effective design for the force amplifier.

The tool holder is preferably removed from the pulling and compression device before mounting the force amplifier and installed in the mechanical force amplifier after mounting. The advantageously provided coupling element enables the transmission of the increased tensile and compressive forces to the tool holder arranged on the mechanical force amplifier and a tensile and/or compressive tool connected to the tool holder in a simple and preferably cost-effective manner.

The supporting unit is preferably designed in such a way that the second threaded nut and/or the coupling element connected to the second threaded nut in a non-rotatable manner are supported on the base body in a rolling manner. Preferably, the supporting unit has at least one rolling element via which the second threaded nut is supported in a rolling manner relative to the base body. This embodiment of the invention ensures increased efficiency, since losses due to friction are reduced. In addition, the use of an appropriately further developed supporting unit provides a particularly simple backlash-free mounting of the second threaded nut, so that tensile and compressive forces are reliably transmitted.

The connection of the force amplifier to the pulling and pressing device can in principle be designed in any way. According to an advantageous embodiment of the invention, it is provided that the connecting section of the force amplifier has a thread or latching bodies for detachable fixing to the connection section of the pulling and compression device having a thread or latching body receptacles. A corresponding design of the connecting section enables a secure and easily detachable connection of the force amplifier to the pulling and compression device without the need for further components and/or securing elements. To release the connection between the force amplifier and the pulling and compression device, it is only necessary to unscrew it from the thread or release the latching connection.

The invention further solves the problem by the hand-held pulling and compression device for driving interchangeable tools, with
a drive unit with a battery-operated electric motor,
a first threaded drive with a first threaded spindle rotatably mounted on a housing body and a first threaded nut rotatably mounted on the first threaded spindle and non-rotatably mounted on the housing body via a bearing unit, and
a coupling unit connectable to a tool holder for transmitting tensile and compressive forces resulting from the direction of rotation of the first threaded spindle from the first threaded nut to the tool holder, wherein
the pulling and compression device is detachably connected to a mechanical force amplifier according to the invention or further developed as described above.

In addition to driving mechanically driven pulling and pressing tools with the maximum force generated via the pulling and compression device via the force amplifier, the hand-held pulling and compression device according to the invention also enables the drive with forces exceeding this maximum force, whereby, if necessary, it is possible to switch between an original drive via the pulling and compression device and the amplified drive via the force amplifier in a simple manner by connecting or disconnecting the force amplifier to the pulling and compression device.

An embodiment of the invention is explained below with reference to the drawings. The drawings show in:

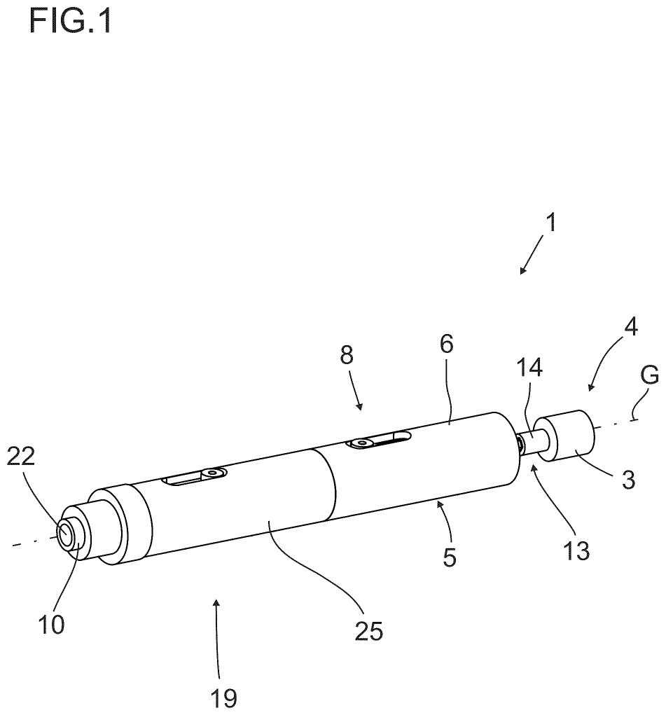

FIG. 1 a perspective view of a schematic representation of a pulling and compression device with a mechanical force amplifier arranged on it;

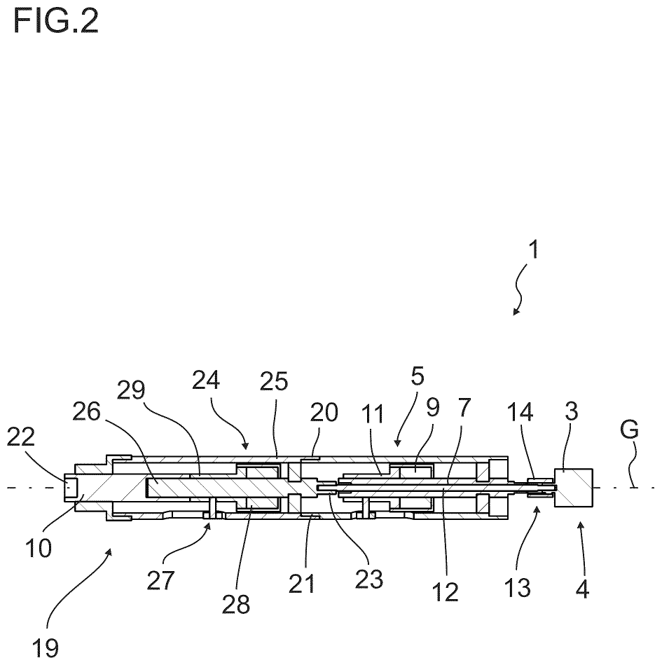

FIG. 2 in a sectional view, a schematic representation of the pulling and compression device of FIG. 1 with the mechanical force amplifier arranged thereon;

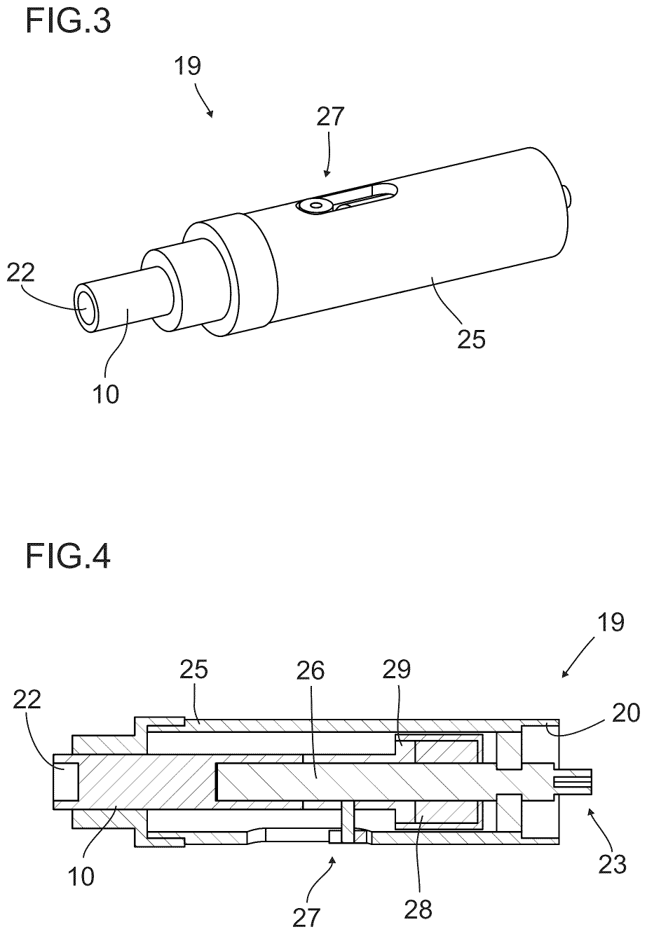

FIG. 3 in a perspective view a schematic representation of the mechanical force amplifier for the hand-held pulling and compression device and

FIG. 4 a sectional view of a schematic representation of the mechanical force amplifier of FIG. 3.

FIG. 1 shows a perspective view of a schematic representation of a pulling and compression device 1 with a drive unit 4 comprising an electric motor 3. A first threaded spindle 7 of a first screw drive 5 is driven by means of the electric motor 3, wherein the first threaded spindle 7 is rotatably mounted on a housing body 6 (see FIG. 2).

In addition to the first threaded spindle 7, the first screw drive 5 has a first threaded nut 9 arranged on the first threaded spindle 7, which is mounted non-rotatably on the housing body 6. The first threaded nut 9 serves to drive a tool holder in the form of a piston rod 10, which is mounted so as to be adjustable in the longitudinal axis direction of the first threaded spindle 7, i.e. in the direction of the threaded spindle axis G. The piston rod 10 is connected to the first threaded nut 9 via a detachably connected coupling unit 11. A bearing unit 8, which is attached to the coupling unit 11, is used for non-rotatable mounting of the first threaded nut 9 on the housing body 6.

The hand-held pulling and compression device has a switching unit 13 for coupling and decoupling the first screw drive 5 from the drive unit 4. The switching unit 13 has a sleeve 14 that can be adjusted in the direction of the threaded spindle axis G. The switching unit 13 can be adjusted between a coupling state connecting the first threaded spindle 7 to the drive unit 4 and a decoupling state separating the first threaded spindle 7 from the drive unit 3, as shown in FIG. 2.

The first threaded spindle is designed as a hollow spindle 7 for receiving a rotating shaft 12 connected to the electric motor 3. The rotating shaft 12 is connected to the electric motor 3 in such a way that the rotating shaft 12 can be rotated independently of the switching unit 13 arranged in the coupling state or in the decoupling state. Furthermore, the rotating shaft 12 is arranged coaxially to the hollow spindle 7.

The switching unit 13 is arranged in the longitudinal direction of the hollow spindle 7 between the first screw drive 5 and the drive unit 4.

With the switching unit 13 arranged in the coupling state, the torque generated by the electric motor 3 of the drive unit is transmitted positively via the sleeve 14 to the hollow spindle 7 of the screw drive 5 and converted by the screw drive 5 into a translatory movement of the coupling unit 11 and the piston rod 10, which may be connected to the coupling unit 11.

To adjust the switching unit 13 from the coupling state to the decoupling state, the sleeve 14 is adjusted relative to the first screw drive 5 along the screw spindle axis G in the direction of the drive unit 4, whereby the positive locking of the sleeve 14 and hollow spindle 7 is released. Via the rotating shaft 12 connected to the drive unit 4, the torque of the electric motor 3 can be tapped in both positions and transmitted at the end of the rotating shaft 12 to a mechanical force amplifier 19 connected to the hand-held pulling and compression device 1.

The mechanical force amplifier 19 shown separately in FIGS. 3 and 4 has a connecting section 20 for detachably fixing the mechanical force amplifier 19 to a connection section 21 of the housing body 6 of the hand-held pulling and compression device 1 and a tool connection 22 for pulling and compression tools. The force amplifier 19 is connectable or connected to the rotating shaft 12 of the pulling and compression device 1 via a coupling section 23.

In addition, the force amplifier 1 has a second screw drive 24 with a second threaded spindle 26 mounted rotatably on a base body 25. The second threaded spindle 26 has a smaller pitch than the hollow spindle 7 of the hand-held pulling and compression device 1 in order to amplify the tensile and compressive forces transmitted to the piston rod 10. The coupling section 23 is arranged on the second threaded spindle 26

In addition to the second threaded spindle 26, the second screw drive 24 also has a second threaded nut 28 arranged on the second threaded spindle 26, which is mounted non-rotatably on the base body 25 via a supporting unit 27. The second threaded nut 28 is used to drive the piston rod 10. The force amplifier 19 has a coupling element 29 that can be connected to the piston rod 10 for transmitting tensile and compressive forces resulting from the direction of rotation of the second threaded spindle 26 from the second threaded nut 28 to the piston rod 10.

Switching between the use of tensile and compressive forces generated by means of the tension-/compression device 1 and the tensile and compressive forces increased by the force amplifier 19 can be carried out in a simple manner by disassembling and assembling the force amplifier 1, whereby the piston rod 10 is removed from the tension-/compression device 1 before mounting the force amplifier 1 and installed in the mechanical force amplifier 1 after mounting.

All the features explained in connection with individual embodiments of the invention can be provided in different combinations for the mechanical force amplifier or the hand-held pulling and compression device in order to realize their advantageous effects, even if these have been described for different embodiments. For example, the screw drives of the tension-/compression device 1 and the mechanical force amplifier 19 are designed identically except for the differently designed threaded spindles 7, 26 in order to enable cost-effective and resource-saving manufacture for the mechanical force amplifier.

### LIST OF REFERENCE SYMBOLS

1 Pulling and compression device
3 Electric motor
4 Drive unit
First screw drive
6 Housing body
7 First threaded spindle (hollow spindle)
8 Storage unit
9 First threaded nut
Tool holder (piston rod)
11 Coupling unit
12 Rotating shaft
13 Switching unit
14 Sleeve
Adjustment element
19 Mechanical force amplifier
20 Connecting section
21 Connection section
22 Tool connection
23 Coupling section
24 Second screw drive
25 Base body
26 Second threaded spindle
27 Supporting unit
28 Second threaded nut
29 Coupling element
G Threaded spindle axis

1. Mechanical force amplifier for a hand-held pulling and compression device with
a drive unit comprising a battery-operated electric motor,
a first threaded drive with a first threaded spindle mounted rotatably on a housing body and a first threaded nut mounted rotatably on the first threaded spindle and non-rotatably on the housing body via a bearing unit, and
a coupling unit connectable to a tool holder for transmitting tensile and compressive forces resulting from the direction of rotation of the first threaded spindle from the first threaded nut to the tool holder,
including a connecting section for detachably fixing the mechanical force amplifier to a connection section of the housing body of the hand-held pulling and compression device and a tool connection for pulling and compression tools.

2. Mechanical force amplifier according to claim 1, including a coupling section for detachable connection to the first threaded spindle.

3. Mechanical force amplifier according to claim 1, including a second screw drive with a second threaded spindle mounted rotatably on a base body and having the coupling section, and a second threaded nut mounted rotatably on the second threaded spindle and non-rotatably on the base body via a supporting unit.

4. Mechanical force amplifier according to claim 1, wherein the second threaded spindle has a smaller pitch than the first threaded spindle of the hand-held pulling and compression device.

5. Mechanical force amplifier according to claim 1, including a coupling element, which can be connected to the tool holder, for transmitting tensile and compressive forces resulting from the direction of rotation of the second threaded spindle from the second threaded nut to the tool holder.

6. Mechanical force amplifier according to claim 1, wherein the connecting section of the force amplifier has a thread or latching bodies for detachable fixing to the connection section of the pulling and compression device having a thread or latching body receptacles.

7. Hand-held pulling and compression device for driving interchangeable tools, with
a drive unit comprising a battery-operated electric motor,
a first threaded drive with a first threaded spindle mounted rotatably on a housing body and a first threaded nut mounted rotatably on the first threaded spindle and non-rotatably on the housing body via a bearing unit, and
a coupling unit connectable to a tool holder for transmitting tensile and compressive forces resulting from the direction of rotation of the first threaded spindle from the first threaded nut to the tool holder,
including a mechanical force amplifier detachably connected to the pulling and compression device according to claim 1.

8. Hand-held pulling and compression device according to claim 7, wherein the first threaded spindle is designed as a hollow spindle for receiving a rotating shaft connected to the drive unit and the mechanical force amplifier is connected to the rotating shaft via a coupling section.

9. Hand-held pulling and compression device according to claim 7, including a switching unit which can be adjusted between a coupling state connecting the first threaded spindle to the drive unit and a decoupling state separating the first threaded spindle from the drive unit.
